(19) United States
(12) Patent Application Publication
(10) Pub. No.: US 2010/0029195 A1
(43) Pub. Date: Feb. 4, 2010

(54) AIR HANDLING UNIT USING MULTIPLE FANS

(76) Inventors: Wais Jalali, Ellicott City, MD (US); Muammer Yazici, Toronto (CA)

Correspondence Address: GIFFORD, KRASS, SPRINKLE,ANDERSON & CITKOWSKI, P.C, PO BOX 7021, TROY, MI, 48007-7021, US

(21) Appl. No.: 12/182,533

(22) Filed: Jul. 30, 2008

(51) Int. Cl. F24F 13/10; F24F 7/007; F04B 17/03; G05B 15/00

(52) U.S. Cl. 454/341; 454/358; 417/410.1; 700/275

(57) ABSTRACT

An air handling unit for supplying air to a building including an exterior housing forming a chamber and having a longitudinal axis and air inlets and an outlet at opposite ends of the housing. An array of plenum fan units is mounted in the housing between its opposite end sections, this array extending transversely relative to the longitudinal axis. A corresponding array of insulated inlet flow concentrators is arranged adjacent to upstream ends of the plenum fan units. Each concentrator forms a flow passage which tapers towards an inlet opening of its respective fan unit. The flow passage is formed by a perforated metal wall circumferentially encased in sound attenuating material. Interior walls are mounted in the housing to separate the fan units from one another. At least one mechanism is mounted at one end of the compartment for each fan unit formed by the interior walls.

### BACKGROUND OF THE INVENTION

This invention relates to air handling units for supplying air to a building interior or to a portion of a building.

A variety of air handling units are known for supplying pressurized air, which can also be conditioned air, to a building interior. It is known to provide an enclosed air handling unit for a building that is not only capable of providing pressurized air to supply the building's interior but is also equipped with means for either cooling the air or heating the air or both. The flow of air passing through the air handling unit can be heated or cooled by means of one or more sets of coils or pipes that are arranged to extend across the flow path and through which a cooling or heating fluid can pass. It is also known to provide air filter devices in such air handling units.

Recent U.S. Pat. No. 7,179,046 issued Feb. 20, 2007 to Huntair Inc. describes an air handling system that includes a plurality of fan units arranged in a fan array and positioned within an air handling compartment. According to the patent specification, there is provided an array controller programmed to operate the plurality of fan units at peak efficiency. A variety of different arrays are described, including a checkerboard array and an array in which the rows of fan units are slightly offset. Adjacent fan units are spaced apart at a distance of between 30% and 60% of a fan wheel diameter Advantages of this type of system according to the patent include a reduction in the length of the airway path, a reduction in the size of the fan unit and its attached motor, and a reduction in the size of an inlet cone which in turn reduces the length of the inlet plenum. Filter banks and/or cooling units can be added to this system either upstream or downstream of the fan units.

The air handling units described herein are capable of supplying pressurized air to a building by means of adjacent fan units mounted in an exterior housing with each fan unit being located in its own compartment.

In an exemplary embodiment of the present air handling unit, there are first and second damper mechanisms provided for each fan unit located at opposite end sections of the compartment for the fan unit. These damper mechanisms can be moved between an open position for operation of the respective fan unit and a closed position when the respective fan unit is not operating.

### SUMMARY OF THE PRESENT DISCLOSURE

According to one embodiment of the present disclosure, an air handling unit for supplying pressurized air to a building interior includes an exterior housing with top, bottom and side walls forming an air handling chamber, this housing having first and second end sections located at opposite ends of the housing. There is at least one air inlet provided in the first end section and an air outlet for the pressurized air provided in the second end section. Adjacent fan units are arranged in the housing between the first and second end sections and these units have fan members which are rotatable about substantially parallel axes of rotation and are substantially aligned in at least one direction perpendicular to the axes of rotation. At least one interior wall is mounted in the housing to separate each fan unit from one or more of the fan units which are adjacent thereto whereby each fan unit is located in its own respective compartment. A first damper mechanism for each fan unit is mounted in an upstream end section of the compartment for the respective fan unit and a second damper mechanism for each fan unit is mounted in the downstream end section of the compartment for the respective fan unit. The first and second dampers for each fan unit are movable between an open position for operation of the respective fan unit and a closed position assumed when the respective fan unit is not operating. The air handling unit is able to operate in a desired manner using the remaining fan unit or fan units when one of the fan units is not usable by the first and second damper mechanisms associated with the one fan unit moving to their closed positions.

In an exemplary version of this air handling unit, there are at least four of the fan units arranged in two adjacent horizontal rows with at least two of the fan units in each row.

According to another embodiment of the present disclosure, an air handling unit for supplying pressurized, conditioned air to a building includes an exterior housing forming an air handling chamber having a horizontal longitudinal axis, at least one air inlet in a first end section of the housing, and at least one air outlet in an opposite end section of the housing. There is also provided a conditioning device for air flowing through the chamber, this device being mounted in the housing. An array of fan units is mounted in the housing between the first and second end sections and extends transversely relative to the longitudinal axis and vertically. Each fan unit is arranged in its own respective compartment through which air can flow from an upstream end to a downstream end of the compartment. The fan units have fan members having a diameter of at least twenty five inches and rotatable about substantially parallel axes, and are separated from one another by interior walls defining the compartments. At least one damper mechanism for each of the fan units is mounted at least one end section of the compartment for each respective fan unit. Each damper mechanism is movable between an open position for running of its respective unit and a closed position to which the damper mechanism moves when the respective fan unit is not operating. The air handling unit is able to operate in a required, predetermined manner using a remainder of the fan units when one of the fan units is not usable by the at least one damper mechanism associated with the one fan unit moving to its respective closed position.

In an exemplary version of the aforementioned air handling unit, the array of fan unit comprises four fan units arranged in two rows, one above the other, and each fan unit comprises a centrifugal fan.

According to another embodiment of the present disclosure, an air handling unit for supplying pressurized air to a building interior includes an exterior housing forming an air handling chamber and having a longitudinal axis, at least one air inlet in a first end section of the housing, and at least one air outlet in an opposite end section of the housing. An array of four or more plenum fan units is mounted in the housing between the first and second end sections, this array extending transversely relative to the longitudinal axis. A corresponding array of insulated, inlet flow concentrators is arranged adjacent to and upstream of the plenum fan units so as to provide one of the inlet flow concentrators for each plenum fan unit. Each inlet flow concentrator forms a flow passage which tapers towards an inlet opening of its respective plenum fan unit, this flow passage being formed by a perforated metal wall which is circumferentially encased in sound attenuating material. The inlet flow concentrators during use of the fan units substantially reduce the level of fan noise reaching the first end section of the housing and the at least one air inlet.

In an exemplary form of the aforementioned air handling unit, each fan unit is separated from adjacent fan units by insulated interior walls so that each fan unit is located in its own compartment through which air can flow from one end of the compartment to an opposite end thereof.

These and other aspects of the disclosed air handling unit will become more readily apparent to those having ordinary skill in the art from the following detailed description taken in conjunction with the accompanying drawings.

### BRIEF DESCRIPTION OF THE DRAWINGS

So that those having ordinary skill in the art to which the present disclosure pertains will more readily understand how to make and use the subject invention, exemplary embodiments thereof will be described in detail herein below with reference to the drawings wherein:

FIG. 1 is a vertical, longitudinal cross-sectional view taken along the line I-I of FIG. 2, this view showing the interior of an air handling unit in accordance with the present disclosure;

FIG. 2 is a horizontal cross-section of the air handling unit of FIG. 1, this view being taken approximately along the line II-II of FIG. 1;

FIG. 3 is a left end elevation of the air handling unit of FIG. 1;

FIG. 4 is a right end elevation of the air handling unit of FIG. 1;

FIG. 5 is a vertical cross-sectional view of the central portion of the air handling unit of FIG. 1;

FIG. 6 is a horizontal cross-section of the central portion of the air handling unit;

FIG. 7 is a control diagram of a control unit to be used for controlling of the air handling unit; and

FIGS. 8A-8D is an exemplary circuit diagram of a control unit in accordance with an example embodiment.

### DETAILED DESCRIPTION OF EXEMPLARY EMBODIMENT(S)

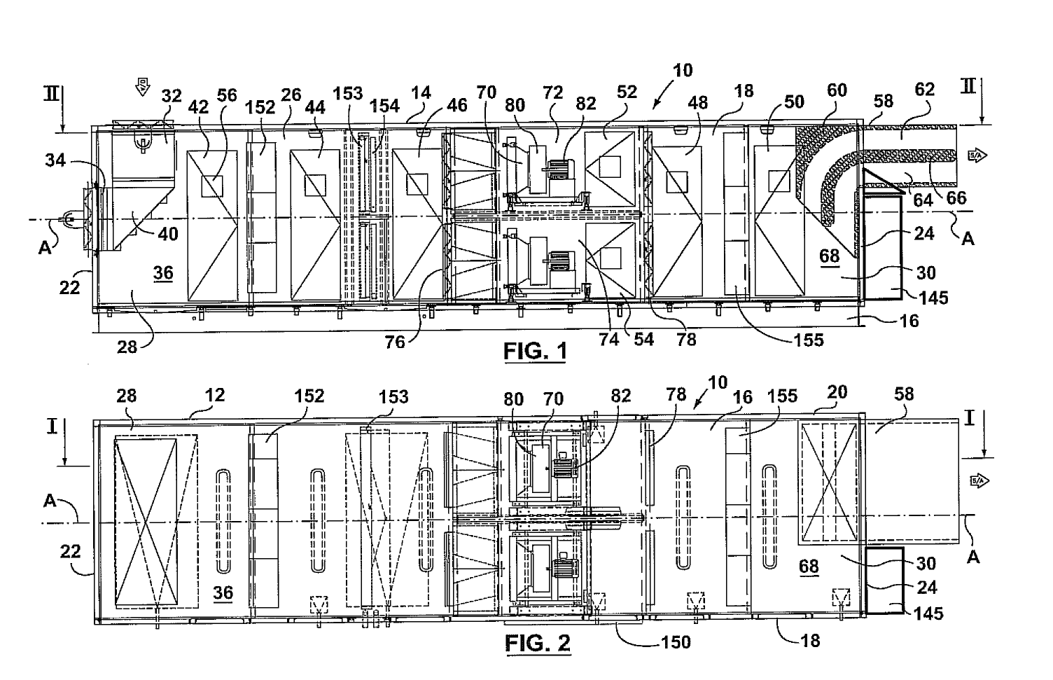

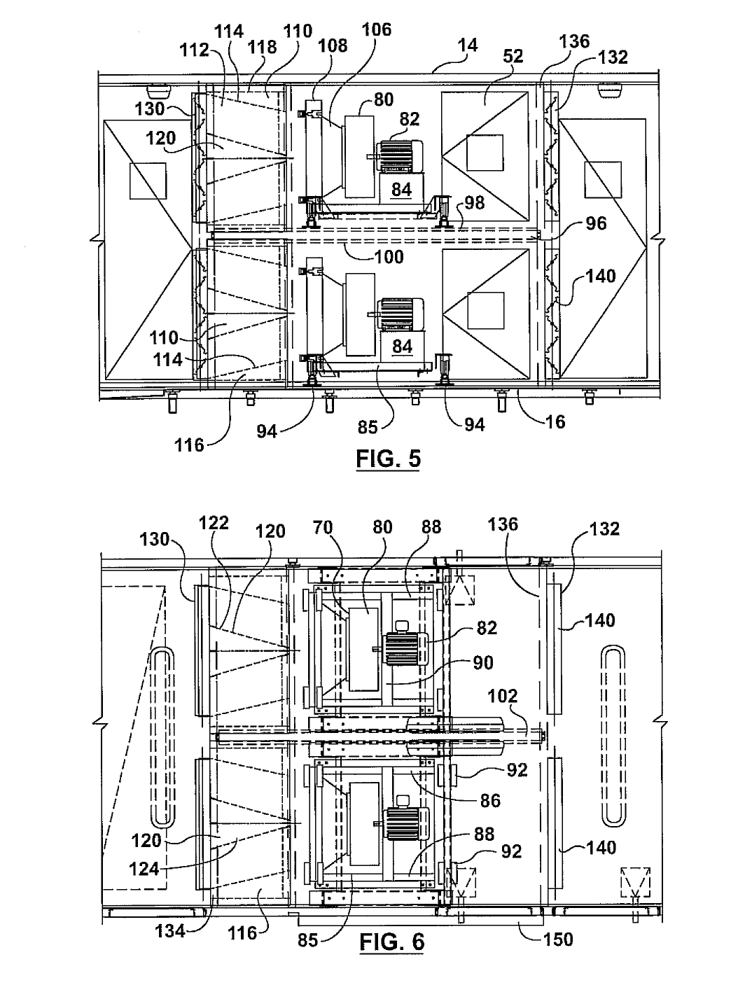

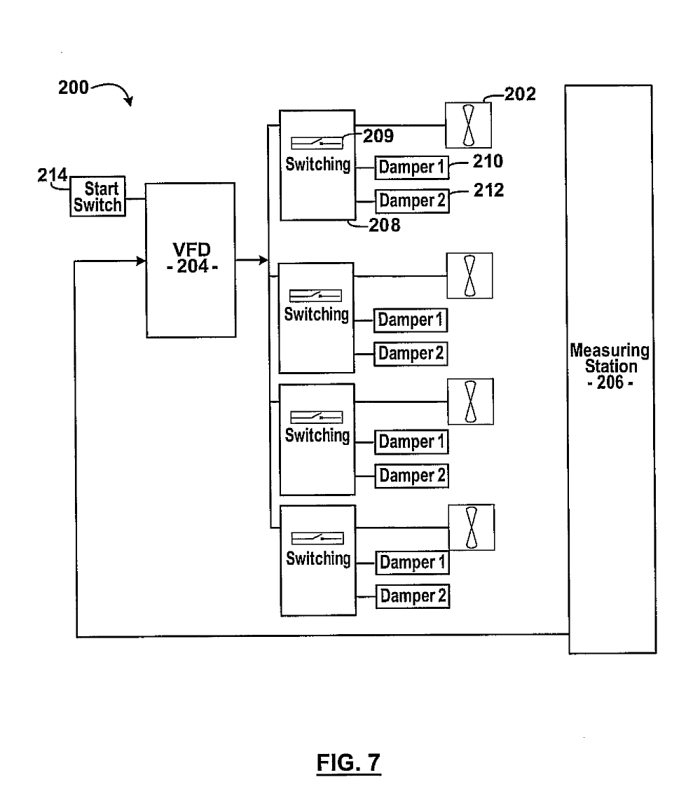

An air handling unit 10 for supplying pressurized air to a building interior (not shown) is illustrated in FIGS. 1 to 4 of the drawings. The illustrated unit is capable of providing not only pressurized air to a building, but also air that has been conditioned, for example, by filters mounted within the unit and/or heating and cooling coils. The unit comprises an exterior housing 12 which includes a top 14, a bottom or floor 16 and side walls, including two opposite longitudinal side walls 18 and 20 and two end walls 22 and 24. In an exemplary embodiment, all of these walls are insulated with sound-attenuating material in a manner known per se. For example, each wall can be constructed with spaced apart inner and outer wall panels covering sound attenuating material. One common form of sound attenuating material is fiberglass in the form of batts but other forms of sound attenuating material are available and can be used, if desired. The inner lining of the walls may be perforated accordingly. The walls may also be insulated with thermal insulated material, wherein the inner lining of the walls would be solid rather than perforated. The housing 12 forms an air handling chamber 26 extending the length of the housing but this chamber is subdivided as illustrated in the drawings into smaller chambers or compartments. The housing 12 also has a first end section 28 and a second end section 30 located at opposite ends of the housing. There is at least one air inlet provided in the first end section 28 and, in the exemplary embodiment, there are two such air inlets 32 and 34. As shown, the air inlet 32 extends through the top of the housing and this inlet can be used to allow outside or external air to flow into a first plenum chamber 36. The second inlet 34 is an inlet for return air coming back from the interior of the building itself. The two incoming air streams are mixed together in the plenum chamber 36. It will be appreciated that the outside air flowing through the inlet 32 provides a source of fresh air for the building while the return air may be heated air or cooled air depending on the condition of the air in the building itself. If desired, an air mixer 40 can be provided to provide an efficient means for mixing the two incoming air streams. This air mixer can, for example be constructed in accordance with U.S. Pat. No. 6,547,433 issued to M & I Heat Transfer Products Ltd. A number of access doors, including an access door 42 can be provided along an appropriate one of the longitudinal sidewalls of the unit, for example, the sidewall 18, as shown. The illustrated air handling unit has five larger access doors 42 to 50, plus short access doors including doors 52 and 54 visible in FIG. 1. Each of these doors can be provided with a window 56 to allow the interior to be viewed without opening the door.

Located at the opposite end of the unit in the second end section 30 is an air outlet 58 for the pressurized air. In an exemplary embodiment as shown, the air outlet is provided in the form of an air outlet unit, the walls of which are insulated with sound attenuating material 60 in a known manner. An air outlet passageway formed by this unit can be split into two outlet passages 62, 64 by a central splitter 66 which extends around a 90 degree bend as shown. The central splitter is also filled with sound attenuating material and the metal walls of the splitter and interior walls of the outlet unit are constructed of perforated sheet metal in a known manner. The use of such an air outlet unit can substantially reduce the amount of sound passing through the air outlet from the interior of the housing and, in particular, from outlet chamber 68.

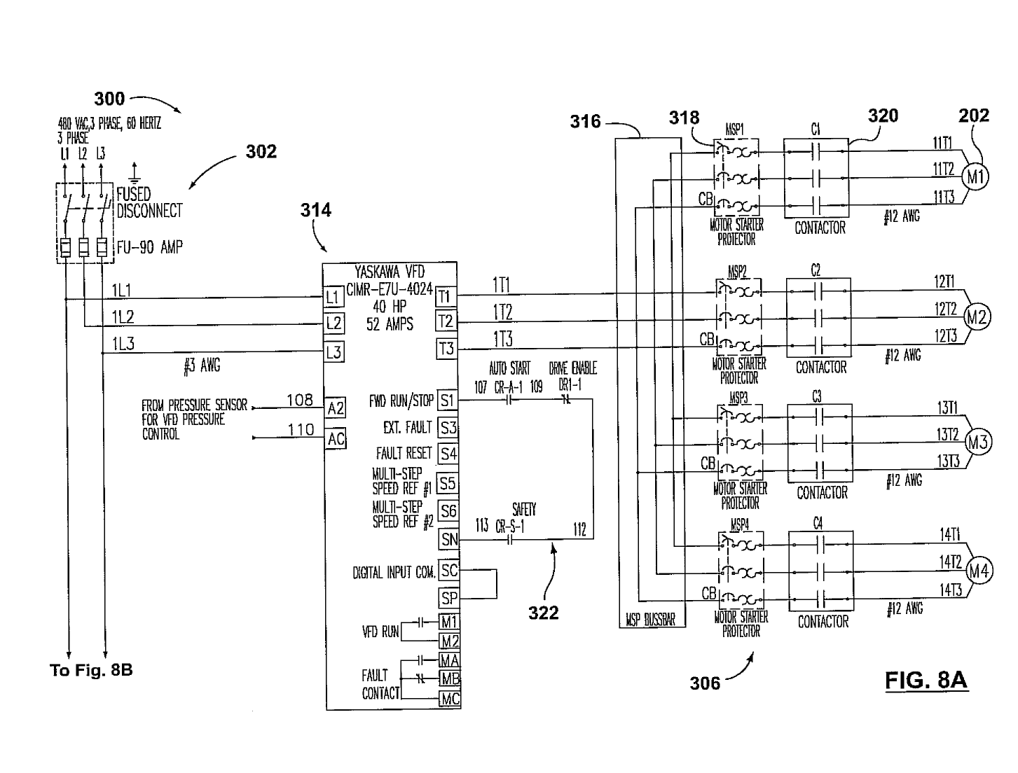

An array of fan units indicated generally at 70 is mounted in the housing 12 between the first and second end sections thereof and this array extends transversely relative to a horizontal, longitudinal axis indicated at A of the housing. Each fan unit in the array is arranged in its own compartment with two of these compartments being indicated at 72, 74 in FIG. 1. The air that is caused to flow through the main chamber of the housing by the fan units can flow from an upstream end indicated at 76 to a downstream end 78 of each compartment when all of the fans are operating. Each fan unit can be a centrifugal or plenum fan having a rotatable centrifugal fan member 80 which in an exemplary embodiment has a diameter of at least fifteen inches. In other embodiments, the fan members having a diameter of at least twenty five inches to sixty inches. The fan members 80 of the array are rotatable about substantially parallel axes and each fan member is rotated by its own electric motor 82. As shown more clearly in FIG. 5, each motor and its respective fan can be supported in an elevated position on motor block 84. Each fan unit optionally includes a horizontally movable carriage 85 similar to the support carriage for a fan described in Canadian Patent No. 2,233,381 issued Feb. 26, 2002, the description and drawings of which are incorporated herein by reference. This carriage can include a horizontally extending support frame, including rear frame member 86, forward frame member 88, and interconnecting frame member 90. The carriage is mounted on four small wheels 92, one at each of the corners of the carriage and these wheels run on two steel rails 94 which can extend out through an opening in the longitudinal sidewall of the air handling unit to allow the fan unit to be readily moved out of the air handling unit for replacement or maintenance, for example. The portions of the rails 94 located outside the air handling unit are not shown in the drawings and indeed these outer sections of the rails would, in some versions, only be installed in a removable manner when maintenance or replacement of the fan motor or fan unit is required. The rails 94 for each lower fan unit can be supported by the bottom or floor 16 of the air handling unit while the rails for each upper air handling unit can be rigidly and securely supported on a horizontal interior wall 96 which, in an exemplary embodiment, is also an insulated wall filled with sound attenuating material. If this wall is constructed as an insulating wall, an upper metal panel 98 and a lower metal panel 100 forming this wall are made of perforated sheet metal in a manner known per se. It will be understood that the upper and lower metal panels are connected together by and supported by suitable metal frame members which also provide structural integrity to this wall.

In the illustrated unit 10, there is at least one additional interior wall 102 which extends in a vertical plane and which also acts to separate adjacent fan units from one another. The wall 102 can extend from the bottom 16 of the unit to the top 14 and this wall as well is preferably insulated with sound attenuating material. In this way, all four walls around each compartment 72, 74 in which a fan unit is located, are insulated with sound attenuating material such as fiberglass. The vertical wall 102 can be constructed using two spaced apart metal panels in a manner similar to the interior wall 96.

In addition to the fan member 80 and its motor, there is mounted on each carriage 84 a frustoconical, metal inlet member 106 which, in a known manner, directs airflow into the inlet in the side of the fan member. The wider, front end of the inlet member is supported by a suitable support frame 108 which is rigidly connected along its bottom to its respective carriage 85.

In order to reduce the amount of sound emanating from the air handling unit in the upstream direction and through the inlets, an exemplary version of the air handling unit is provided with an inlet flow concentrator 110, one in each compartment on the inlet side of the fan unit. This inlet flow concentrator not only substantially reduces the sound transmitted in the upstream direction from its respective fan unit, but also directs airflow into the inlet member or inlet cone 106 of its respective fan unit. Each flow concentrator forms an airflow inlet passageway 112 which is tapered in a direction towards the inlet of the fan unit. This inlet passageway is formed by a perforated metal wall 114 which is an interior wall surrounded by sound attenuating material at 116. This material can be fiberglass batting but other forms of sound attenuating material can also be used. The sound attenuating material can be contained by exterior metal walls 118 which can be made of solid sheet metal. These exterior walls can extend along the top, bottom and opposite vertical sides of the flow concentrator. In an exemplary version of the flow concentrator, there is a central cone member 120 having a perforated sheet metal exterior 122 and mounted coaxially in the flow passage of the concentrator. Each cone member tapers in the same direction of taper as its respective flow passage and contains a suitable sound attenuating material at 124, such as fiberglass batting. In the illustrated embodiment, each of the two lower flow concentrators 110 is mounted on and supported by the floor 16 of the air handling unit while each of the two upper flow concentrators is mounted on and supported by the interior wall 96. It will be understood that each flow concentrator is separate from the adjacent inlet member 106 of the fan unit and thus the fan unit can be moved outwardly on its carriage for repair or otherwise without moving the flow concentrator. In an exemplary version of the flow concentrator, the conical exterior sheet metal wall of the cone member 120 is also perforated with numerous small holes in a manner known per-se.

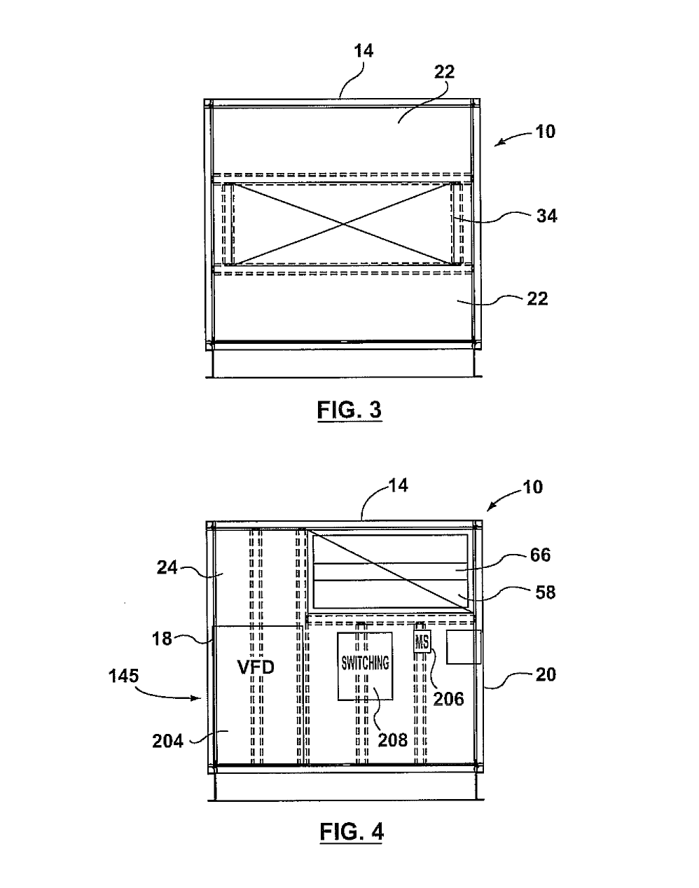

A significant feature of the air handling unit 10 is the provision of at least one damper mechanism at one end of each compartment 72. In the illustrated embodiment there are two damper mechanisms, a first damper mechanism 130 and a second damper mechanism 132 for each fan unit in order to control the flow of air through each compartment 72, 74. As illustrated, each first damper mechanism is mounted in an upstream end section 134 of its respective compartment and each second damper mechanism is mounted in a downstream end section of the compartment. Each of these damper mechanisms can be constructed in a manner known per se using a series of vanes 140. As illustrated, these flat vanes extend horizontally but it is also possible to use vertically extending vanes. The illustrated series of vanes for each damper mechanism pivot about parallel, horizontal axes. The vanes of each damper mechanism can be moved together and at the same time by a suitable pivoting mechanism which can be of known construction. The damper mechanisms for each fan unit can be operated independently by a suitable control separately from the damper mechanisms for the other fan units. In an exemplary embodiment, each of the first and second damper mechanisms is operated by its own electric motor (not shown) and all of the electric motors for these damper mechanisms can be controlled by an electric control panel indicated generally at 145 in FIGS. 1 and 2. The control for the damper mechanisms is able to selectively move the first and second damper mechanisms for each fan unit between an open position for operation of the respective fan unit and a closed position used when the fan unit is not operating. Thus, with the use of these damper mechanisms, the air handling unit 10 is able to operate in a desired manner using the remaining fan unit or fan units when one of the fan units is not usable by moving the first and second damper mechanisms associated with the unusable fan unit to their closed positions. Instead of being electrically controlled, both damper mechanisms can be back draft dampers which Per se are of known construction and which do not require controls to operate. Such dampers are less expensive and they are opened by airflow from the fan and closed by the force of gravity. An advantage of electrically controlled dampers is that they can provide a better air seal. It can also be appreciated that the larger size fan members from twenty five inches to sixty inches benefit from being arranged in its own compartment in accordance with the present configuration, for example each having an associated damper.

The illustrated exemplary embodiment of an air handling unit has four of the fan units arranged in two adjacent horizontal rows with two of the fan units in each row. However, an array of fan units having more than four fan units is also possible, depending on the particular air handling requirements for the building or location. It is also possible to construct an air handling unit having one or more features disclosed herein and only two fan units which are arranged horizontally side-by-side or with only two fan units located one above the other. In any event, the fan units are substantially aligned in at least one direction perpendicular to their axes of rotation.

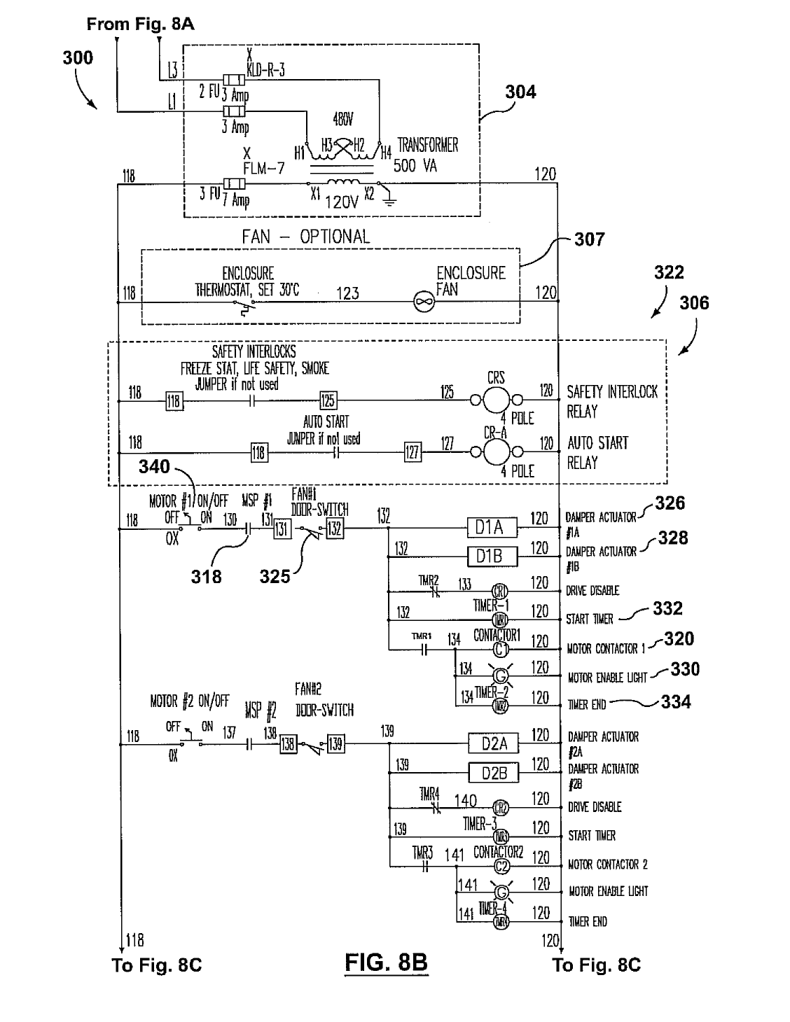

As indicated, each of the fan units can be moved horizontally on its carriage out of the housing 12 through an opening in one of the longitudinal side walls 18, 20. In the illustrated embodiment, these openings are in the side wall 18 and a cover in the form of a rectangular panel 150 can be provided for each opening (see FIGS. 2 and 6). The cover 150 is removably or movably mounted in any suitable manner, for example, by door hinges. If space limitations require that each cover not be pivotably mounted, it can be slidably mounted on a track.

The air handling unit 10, in a manner known per se can be equipped with various sets of cooling coils, filters and humidifiers through which the incoming or outgoing air must flow. Components of this type (which provide conditioned air) are indicated generally in FIGS. 1 and 2 at 152 to 155.

In the illustrated, exemplary air handling unit, each of the four fan members 80 can have a proper clearance from the side walls surrounding same and this results in plenum pressure losses which are less than would otherwise be the case. The recommended industry standard for fan clearance is one half the diameter of the fan wheel and this is achievable with the air handling unit described herein.

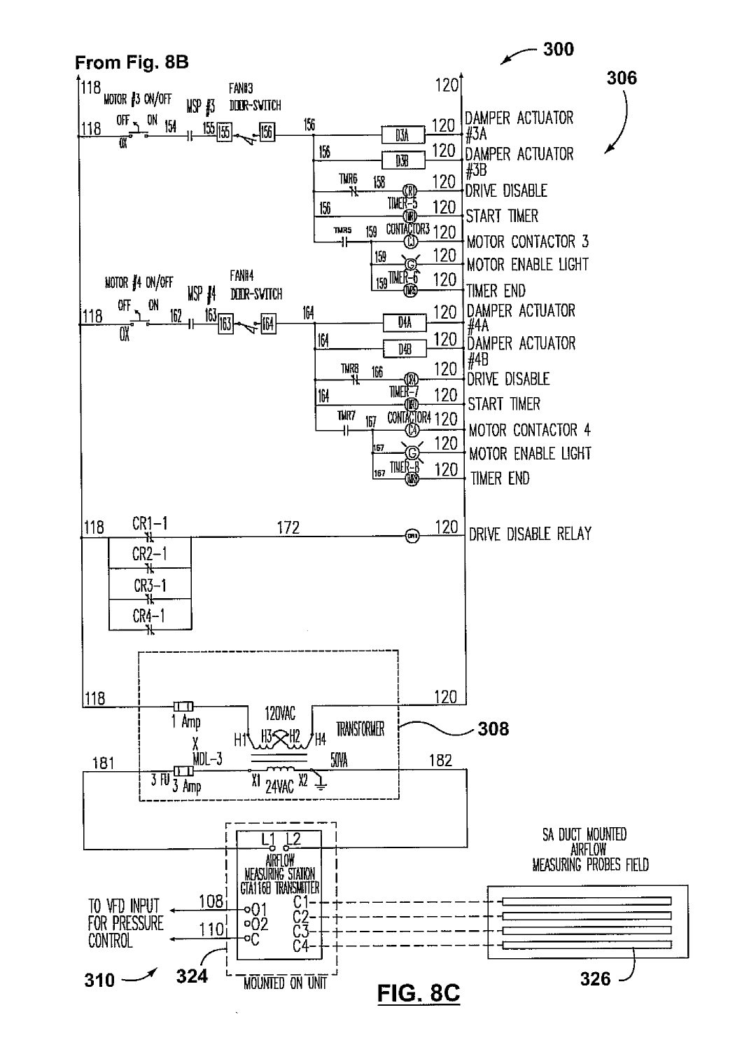

Reference is now made to FIG. 7, which shows a control diagram of a control unit 200 for the electric control panel 145 (FIGS. 1 and 2). The control unit 200 is generally used to control and drive each fan motor of each respective fan unit in the array, and to close the associated damper mechanisms when a fault occurs in a particular fan unit. The operation of one fan motor 202 in the array will now be described. The fan motor 202 is driven by a fan drive unit such as a variable frequency driver 204. A start switch 214 controls the variable frequency driver 204. The variable frequency driver 204 outputs a drive signal to the fan motor 202 in proportion to the frequency of a received AC signal. A measuring station 206 provides the AC signal to the variable frequency driver 204 dependent on a measured condition of the air handling unit 10. Without intending to be limiting, examples of the measured condition include air pressure, air flow and temperature. A switching control module 208 is used to selectively activate the fan motor 202. As shown, the switching control module 208 is also configured to operate a first damper actuator 210 and second damper actuator 212 for opening and closing of associated damper mechanisms 130, 132 (shown in FIGS. 5 and 6). The switching control module 208 may include a fault detector such as a suitable circuit breaker 209. Other fault detectors may also be use such as a fault switch, fuse, sensor, etc. The circuit breaker 209 may be used for detecting a fault in the associated fan unit. A detected fault results in the circuit breaker 209 de-activating the associated fan motor 202, and the switching control module 208 further responds by de-activating the first and second damper actuators 210, 212. In some example embodiments, this switching may be achieved by coupling the circuit breaker 209 in series with the first and second damper actuators 210, 212. A fault in the circuit breaker 209 would therefore no longer drive the first and second damper actuators 210, 212 as well as the associated fan motor 202. A similar configuration may be used for controlling and driving the other three fan units in the array, as illustrated in FIG. 7.

In operation, the variable frequency driver 204 is configured with a particular set point parameter dependent on the particular system or building requirements. Each desired fan unit is switched on for use (for example using each associated switching control module 208). The associated damper actuators 210, 212 are also activated by the switching control module 208 to open the associated damper mechanisms 130, 132 (FIGS. 5 and 6). The start switch 214 is thereafter turned on to activate the variable frequency driver 204, and subsequently the variable frequency driver 204 operates to drive the fan motor 202 in dependence of the signal received from the measuring station 206. If a fan unit fails (e.g., the circuit breaker 209 trips), the switching control module 208 no longer actuates the corresponding damper actuators 210, 212 and therefore the associated damper mechanisms 130, 132 (FIGS. 5 and 6) are closed by the damper actuators 210, 212. A failing fan unit also results in the measuring station 206 detecting a drop in the measured condition. The variable frequency driver 204 receives the appropriate reduced frequency signal from the measuring station 206 and provides additional drive to the remaining operational fan units to compensate for the drop in the measured condition.

In an example embodiment, the variable frequency driver 204 is a Yaskawa™ Variable Frequency Driver, which is used to provide 480V three-phase power to drive the fan motors, and is controllable in the manner as described above. In some example embodiments, the variable frequency driver 204 may be bypassed altogether such that the fan motors and damper actuators are activated in a binary on or off state (i.e., without variability dependent from the measuring station 206). The measuring station 206 may for example include measuring probes (not shown) or vanes mounted at or about the air outlet 58 (FIGS. 1 and 2), as is known per se.

As can be appreciated, the switching control module 208 may include a manual switch or button, a soft switch controllable by an appropriate control signal, and/or appropriate circuitry configured to operate in the above-described manner.

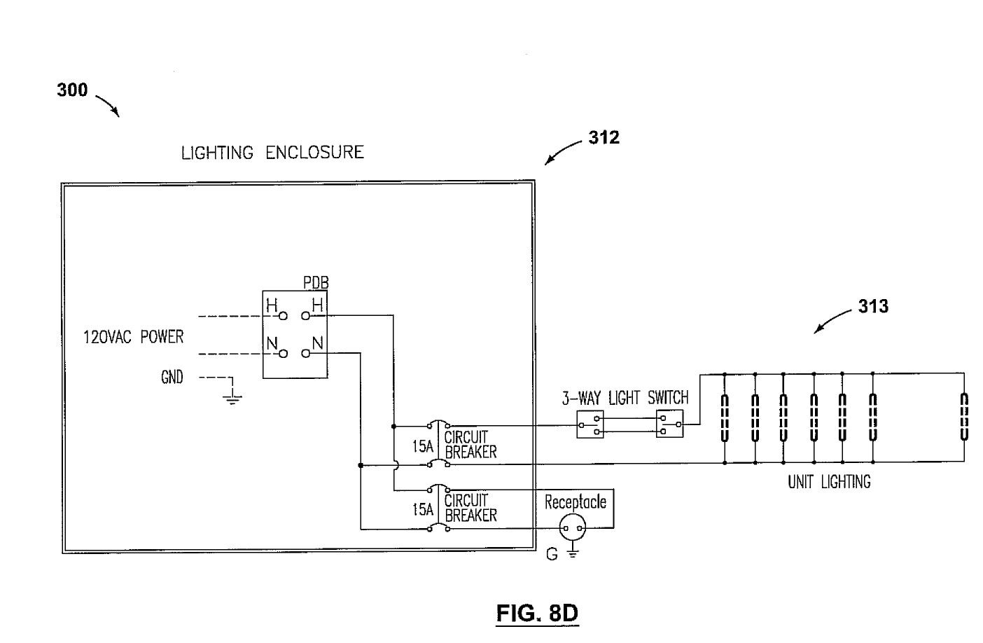

Reference is now made to FIG. 8, which shows a circuit diagram of the control unit 200 in accordance with an example embodiment. A circuit 300 as shown includes a power supply circuit 302 which provides three-phase 480 VAC power to a variable frequency driver 314. A first transformer circuit 304 receives two leads from the three-phase 480 VAC power and outputs 120 VAC to be used in a switching circuitry 306. A second transformer circuit 304 converts the 120 VAC to 24 VAC for use by a measuring station circuitry 310. As shown, the 120 VAC may also power an optional fan 307 for cooling of the circuit 300 and the general surrounding area. A lighting circuit 312 may also receive 120 VAC for powering of unit lighting 313 in or around the fan units.

Each of the three phases from the variable frequency driver 314 is connected via a bus 316 for driving of each of the three phases of each fan motor in the array. The control of one fan motor 202 in the array will now be described with respect to the circuit 300. The fan motor 202 is driven by the variable frequency driver 314 and may be controlled by a motor starter protector 318 or a motor contactor 320 (of which are located in series, as shown). The contactor 320 may be turned on and off by a motor on/off switch 340 mounted on a control panel 145. An auto start circuit 214 controls the variable frequency driver 204. The variable frequency driver 204 outputs a drive signal to the fan motor 202 in proportion to the frequency of a received AC signal from the measuring station circuit 310. The measuring station circuit 310 includes a measuring station transmitter 324 coupled to measuring probes 326 mounted at or about the air outlet 58 (FIGS. 1 and 2).

The switching circuit 306 also includes damper actuators 326, 328 for opening and closing of associated damper mechanisms 130, 132 (shown in FIGS. 5 and 6). A fan door switch 325 is used to de-activate the fan motor 202 and associated damper actuators 130, 132 when the associated fan door is opened. As shown, the switching circuit 306 may be configured to switch other mechanisms such as on/off fan motor indicator lights 330, start timer 332, and end timer 334, depending on the particular application. If the motor starter protector 318 trips, it can be appreciated that the damper actuators 130, 132 will no longer be actuated. A similar configuration may be used for controlling and driving the other three fan units in the array, as illustrated in FIG. 8.

The control unit may also include two similar fan drive units (e.g. two variable frequency drivers), each of which can control the operation of all fans of the array. Thus, if one of the drive units should fail, the other redundant drive unit is connected or activated to automatically begin to operate. Only one of these two drive units is operated at any one time.

Although the control unit is shown in an open loop configuration, it can be appreciated that other configurations may be implemented, for example a closed loop system. In such a system a signal may be detected directly from the fan motor and appropriately processed for sending to the variable frequency driver).

Although the illustrated exemplary embodiment has first and second damper mechanisms located on opposite sides of the respective fan unit, it is also possible to construct an air handling unit with only one damper mechanism provided for each fan unit mounted at or adjacent at least one end of the compartment for the fan unit. This at least one damper is movable between an open position allowing airflow through the compartment and a closed position preventing airflow through the compartment. If only one damper mechanism is provided for each fan unit, this damper mechanism can be provided on the inlet side of the fan unit, ie., at the location of the illustrated first damper mechanism 130 shown in FIGS. 5 and 6, or at the outlet side of the fan unit.

It will be appreciated that the provision of first and second damper mechanisms for each fan unit in an exemplary version of the air handling unit is quite advantageous because, if one fan unit should fail or require maintenance, it can be isolated from the other fan units so that the others can continue operating while the maintenance work is being performed. This can be important in buildings requiring a certain specified amount of ventilation or heating air to be provided to the interior of the building at all times. In the event that one of the fan units must be shut down, the remaining fan units can, if necessary, be operated at a higher speed so that the total amount of air flow provided by this system still meets the specified or required amount or range. Once the fan unit has been replaced or repaired, it can be moved back into its respective compartment and then brought on line by opening up its respective damper or dampers.

While the present invention has been illustrated and described as embodied in various exemplary embodiments, ie., embodiments having particular utility for providing pressurized and/or conditioned air to a building, it is understood that the present invention is not limited to the details shown herein, since it will be understood that various omissions, modifications, substitutions and changes in the forms and details of the disclosed units and systems and their operation may be made by those skilled in the art without departing in any way from the spirit or scope of the present invention. For example, those of ordinary skill in the art will readily adapt the present disclosure for various other applications without departing from the spirit or scope of the present invention.

I claim:

1. An air handling unit for supplying pressurized air to a building interior, said unit comprising:
an exterior housing forming an air handling chamber, said housing having first and second end sections located at opposite ends of the housing;
at least one air inlet provided in said first end section;
an air outlet for said pressurized air provided in said second end section;
adjacent fan units arranged in said housing between said first and second end sections, said fan units having fan members which are rotatable about substantially parallel axes of rotation and being substantially aligned in at least one direction perpendicular to said axes of rotation;
at least one interior wall mounted in said housing to separate each fan unit from one or more of said fan units which are adjacent thereto whereby each fan unit is located in its own respective compartment;
a first damper mechanism for each fan unit mounted in an upstream end section of the compartment for the respective fan unit; and
a second damper mechanism for each fan unit mounted in a downstream end section of the compartment of the respective fan unit,
the first and second damper mechanisms for each fan unit moveable between an open position for operation of the respective fan unit and a closed position when the respective fan unit is not operating,
wherein said air handling unit is able to operate in a desired manner using the remaining fan unit or fan units when one of said fan units is not usable by the first and second damper mechanisms associated with said one fan unit moving to their closed positions.

2. An air handling unit according to claim 1 including an electric control capable of selectively moving the first and second damper mechanism for each fan unit between said closed and open positions.

3. An air handling unit according to claim 1 including at least four of said fan units arranged in two adjacent horizontal rows with at least two of said fan units in each row.

4. An air handling unit according to claim 1 wherein said housing includes top, bottom and side walls and both the walls of said housing and said at least one interior wall are insulated with sound attenuating material.

5. An air handling unit according to claim 3 wherein each fan unit comprises a centrifugal fan and an electric motor operably connected to the centrifugal fan in order to drive same.

6. An air handling unit according to claim 5 wherein each fan unit includes a horizontally movable carriage on which the centrifugal fan and motor for the respective fan unit are mounted.

7. An air handling unit according to claim 1 wherein the control includes a fault detector for each fan unit for de-activating the associated fan unit in response to a detected fault and the air handling unit in response to the detected fault moving the first and second damper mechanisms of the associated fan unit to their closed positions.

8. An air handling unit according to claim 3 including an inlet flow concentrator mounted in each compartment so as to direct airflow into an inlet of the fan unit located in the respective compartment, said flow concentrator forming an airflow inlet passageway which is tapered in a direction towards said inlet of the fan unit, wherein said inlet passageway is formed by a perforated metal wall, which is surrounded by sound-attenuating material.

9. An air handling unit according to claim 3 including a first fan drive control unit and a second, redundant fan drive control unit, each capable of controlling operation of all said fan units independent of the other fan drive control unit.

10. An air handling unit for supplying pressurized, conditioned air to a building, said unit comprising:
an exterior housing forming an air handling chamber and having a horizontal longitudinal axis, at least one air inlet in a first end section of the housing, and at least one air outlet in an opposite second end section of the housing;
a conditioning device for air flowing through said chamber, said conditioning device being mounted in said housing;
an array of fan units mounted in said housing between said first and second end sections and extending transversely relative to said longitudinal axis and vertically, each fan unit being arranged in its own compartment through which air can flow from an upstream end to a downstream end of the respective compartment, said fan units having fan members having a diameter of at least twenty five inches rotatable about substantially parallel axes, said fan units being separated from one another by interior walls defining the compartments; and
at least one damper mechanisms for each of said fan units mounted in at least one end section of the compartment for each respective fan unit, each damper mechanism being movable between an open position for running of its respective fan unit and a closed position to which the damper mechanism moves when its respective fan unit is not operating,
wherein said air handling unit is able to operate in a required predetermined manner using a remainder of the fan units when one of said fan units is not usable by the at least one damper mechanism associated with said one fan unit moving to its respective closed position.

11. An air handling unit according to claim 10 wherein said array of fan units comprises four units arranged in two rows one above the other and each fan unit comprises a centrifugal fan.

12. An air handling unit according to claim 10 wherein clearance distances between a circumferential exterior of each fan wheel and the interior walls defining the compartment for the respective fan unit are equal to at least one half of the diameter of the fan wheel.

13. An air handling unit according to claim 10 wherein said exterior housing is formed of insulated exterior walls containing sound attenuating material and said compartments are defined by a portion of said exterior walls and horizontal and vertical interior walls containing sound attenuating material.

14. An air handling unit according to claim 13 wherein each fan unit includes a centrifugal fan, an electric motor connected to said centrifugal fan in order to drive same, and a horizontally movable carriage on which the centrifugal fan and its motor are mounted.

15. An air handling unit according to claim 10 including a fault detector for each fan unit for de-activating the associated fan unit in response to a detected fault and the air handling unit in response to the detected fault moving the at least one damper mechanism of the associated fan unit to its closed position.

16. An air handling unit according to claim 10 wherein there are two of said at least one damper mechanism for each fan unit mounted at opposite end sections of the compartment for each fan unit.

17. An air handling unit for supplying pressurized air to a building interior, said unit comprising:
an exterior housing forming an air handling chamber and having a longitudinal axis, at least one air inlet in a first end section of the housing and at least one air outlet in an opposite end section of the housing,
an array of four or more plenum fan units mounted in said housing between said first and second end sections, said array extending transversely relative to said longitudinal axis, and
a corresponding array of insulated inlet flow concentrators arranged adjacent to and upstream of said plenum fan units so as to provide one of said inlet flow concentrators for each plenum fan unit, each inlet flow concentrator forming a flow passage which tapers towards an inlet opening of its respective plenum fan unit, said flow passage being formed by a perforated metal wall which is circumferentially encased in sound attenuating material,
wherein said inlet flow concentrators during use of the fan units substantially reduce the level of fan noise reaching said first end section of the housing and said at least one air inlet.

18. An air handling unit according to claim 17 where each fan unit is separated from adjacent fan units by insulated interior walls so that each fan unit is located in its own compartment through which air can flow from one end of the compartment to an opposite end thereof.

19. An air handling unit according to claim 17 wherein a central cone member having a perforated metal exterior is mounted coaxially in the flow passage of each inlet flow concentrator, said cone member tapering in the same direction of taper of its respective flow passage and containing sound attenuating material.

20. An air handling unit according to claim 18 wherein each fan unit includes a plenum centrifugal fan, a motor connected to said centrifugal fan in order to drive same, and a horizontally movable carriage on which the centrifugal fan and its motor are mounted, and wherein each fan unit is movable horizontally on a track and horizontally away from its respective inlet flow concentrator.

21. An air handling unit according to claim 18 including at least one damper mechanism for each fan unit mounted at or adjacent at least one end of the compartment for the respective fan unit, said at least one damper being movable between an open position allowing airflow through the compartment and a closed position preventing airflow through the compartment.

22. An air handling unit according to claim 18 including first and second damper mechanisms for each fan unit, said first damper mechanism being arranged at a wide intake end of the respective inlet flow concentrator and the second damper mechanism being located at a downstream end of the compartment for the respective fan unit.
